(19) United States
(12) Patent Application Publication
(10) Pub. No.: US 2008/0000677 A1
(43) Pub. Date: Jan. 3, 2008

(54) Printed circuit board

(75) Inventors: Ying-Tso Lai, Tu-Cheng (TW); Yu-Chang Pai, Tu-Cheng (TW); Shou-Kuo Hsu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,921

(22) Filed: Oct. 27, 2006

(30) Foreign Application Priority Data
Jun. 30, 2006 (CN) 200610061420.6

(51) Int. Cl. H01R 12/00

(52) U.S. Cl. 174/261

(57) ABSTRACT

A printed circuit board (PCB) includes at least one power trace. A plurality of etched portions are defined in the at least one power trace, acting as electromagnetic bandgaps for transferring resonant frequencies produced around the at least one power trace to avoid working frequencies of the PCB, thereby reducing power noise around the at least one power trace.

### 1. FIELD OF THE INVENTION

The present invention relates to printed circuit boards (PCBs), and more particularly, to a PCB for reducing power noise therein.

### 2. DESCRIPTION OF RELATED ART

Generally speaking, noise can not be avoided in PCBs, such as coupling/crosstalk between signals, electro-magnetic interference (EMI) from high-frequency signals, and power noise from power delivery systems, especially the simultaneous switching noise (SSN) whose resonant frequencies may interfere with working frequencies of the PCBs.

Some methods are applied for reducing power noise from power delivery systems, and a conventional method is to add some de-coupling capacitors in a PCB. The de-coupling capacitors can store redundant energy therein, and release the energy to the power delivery system at an appropriate moment. However, this method uses precious space for arranging the de-coupling capacitors, and also increases design complexity of the PCB.

What is desired, therefore, is to provide a PCB which can effectively and easily reduce power noise therein.

### SUMMARY OF THE INVENTION

An exemplary printed circuit board (PCB) includes at least one power trace. A plurality of etched portions are defined in the at least one power trace, acting as electromagnetic bandgaps for transferring resonant frequencies produced around the at least one power trace to avoid working frequencies of the PCB, thereby reducing power noise around the at least one power trace.

Other advantages and novel features will become more apparent from the following detailed description when taken in conjunction with the accompanying drawings, in which:

### BRIEF DESCRIPTION OF THE DRAWINGS

FIG. 1 is a schematic view of part of a PCB in accordance with a first preferred embodiment of the present invention;

FIG. 2 is a schematic view of part of a PCB in accordance with a second preferred embodiment of the present invention; and

FIG. 3 is a graph of system radiant energy in relation to frequency of a conventional PCB, the PCB of FIG. 1, and the PCB of FIG. 2.

### DETAILED DESCRIPTION OF THE INVENTION

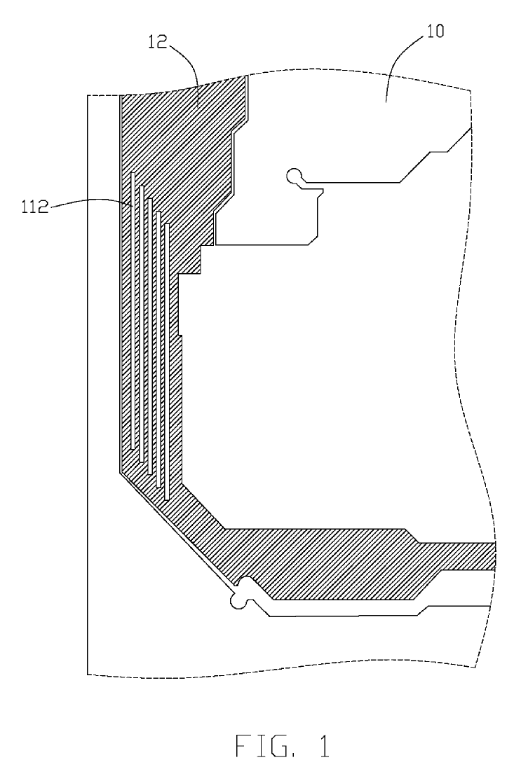

Referring to FIG. 1, a printed circuit board (PCB) 10 in accordance with a first preferred embodiment of the present invention is shown. The PCB 10 includes a power delivery system having at least one power trace 12 arranged therein, and other traces are not shown. The power delivery system can be in a signal layer or a power layer of the PCB 10. A plurality of parallel lengthwise (along the power trace 12) etched grooves 112 are defined in the power trace 12 and act as electromagnetic bandgaps. The grooves 112 will increase partial inductance of the power trace 12, and resonant frequencies produced around the power trace 12 will be transferred, thus the transferred resonant frequencies can avoid working frequencies of the PCB, thereby reducing power noise around the power trace 12. Other power traces or power planes can also be designed like the power trace 12 for reducing the power noise therein.

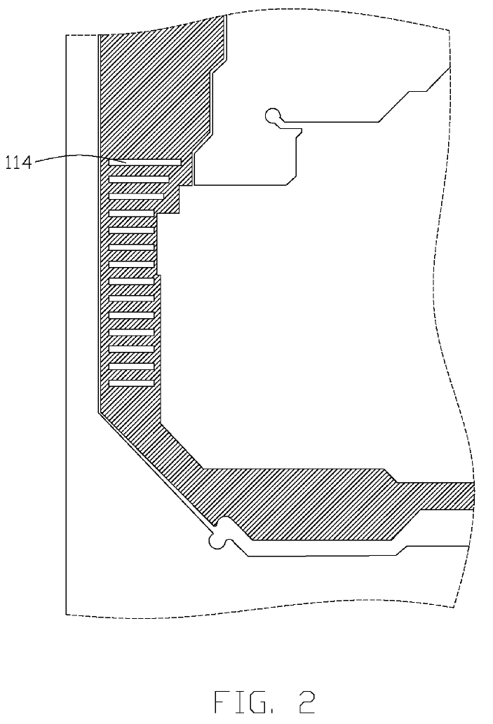

Referring also to FIG. 2, a printed circuit board (PCB) in accordance with a second preferred embodiment of the present invention is shown. This embodiment is similar to the first embodiment, except that in place of the lengthwise grooves 112 a plurality of parallel widthwise etched grooves 114 (perpendicular to the lengthwise grooves 112 of the first embodiment) are provided. In this embodiment, the grooves 114 have the same function as the grooves 112. In addition, each of etched portions of the power trace 12 of the first and second embodiments (the grooves 112 and 114 are the etched portions of the power trace 12) also can be in other geometrical shapes such as square, triangle, circle, ellipse, or any desired geometrical shape at a designer's choice, and each etched portion also can be defined in any position and orientation of the power trace 12 according to need.

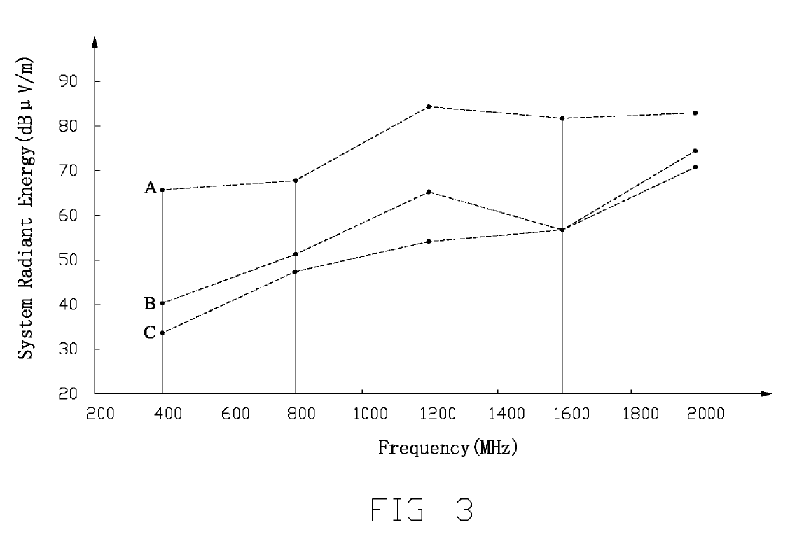

Referring also to FIG. 3, graph of system radiant energy in relation to frequency between a conventional PCB (not shown), the PCB 10 of the first embodiment, and the PCB of the second embodiment is shown. The conventional PCB is similar to the first embodiment, but has no grooves in its power traces. The system radiant energy includes signal radiant energy and power noise radiant energy. In this graph, “A” denotes system radiant energy at some working frequencies of the conventional PCB, “B” denotes system radiant energy at some working frequencies of the PCB 10 of the first embodiment, and “C” denotes system radiant energy at some working frequencies of the PCB of the second embodiment. This graph shows that, the system radiant energy of the two PCBs of the two embodiments of the present invention are both less than the system radiant energy of the conventional PCB at each working frequency, namely the two PCBs can reduce power noise therein effectively, and the two PCBs do not require additional elements to achieve this, such as de-coupling capacitors, for reducing power noise.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material, and arrangement of parts within the principles of the invention to the full extent indicated by the broad general meaning of the terms in which the appended claims are expressed.

What is claimed is:

1. A printed circuit board (PCB) comprising:
at least one power trace defining a plurality of etched portions therein acting as electromagnetic bandgaps for transferring resonant frequencies produced around the at least one power trace to avoid working frequencies of the PCB, thereby reducing power noise around the at least one power trace.

2. The PCB as claimed in claim 1, wherein the etched portions includes a plurality of grooves defined in the at least one power trace.

3. The PCB as claimed in claim 2, wherein the grooves are parallel to each other.

4. The PCB as claimed in claim 3, wherein each of the grooves is defined lengthwise in the at least one power trace.

5. The PCB as claimed in claim 3, wherein each of the grooves is defined widthwise in the at least one power trace.

6. A printed circuit board (PCB) comprising:
a power delivery system comprising at least one power trace configured for transmitting power, the at least one power trace defining a plurality of grooves acting as electromagnetic bandgaps for transferring resonant frequencies produced around the at least one power trace to avoid working frequencies of the PCB, thereby reducing power noise around the at least one power trace.

7. The PCB as claimed in claim 6, wherein the grooves are parallel to each other.

8. The PCB as claimed in claim 7, wherein each of the grooves is defined lengthwise in the at least one power trace.

9. The PCB as claimed in claim 7, wherein each of the grooves is defined widthwise in the at least one power trace.

10. The PCB as claimed in claim 6, wherein the power delivery system is in a signal layer or a power layer of the PCB.
